(19) United States
(12) Patent Application Publication
(10) Pub. No.: US 2014/0058879 A1
(43) Pub. Date: Feb. 27, 2014

(54) ONLINE MARKETPLACE FOR TRANSLATION SERVICES

(71) Applicant: Nicola Cancedda, Grenoble (FR)

(72) Inventor: Nicola Cancedda, Grenoble (FR)

(73) Assignee: XEROX CORPORATION, Norwalk, CT (US)

(21) Appl. No.: 13/592,720

(22) Filed: Aug. 23, 2012

(51) Int. Cl. G06Q 30/06

(52) U.S. Cl. 705/26.4

(57) ABSTRACT

A method, system, and computer program product for implementing an online marketplace for translation services is disclosed. A plurality of requirements is received from a client and are sent to one or more service providers. Further, service quotations from the one or more service providers are received. Based on the plurality of requirements and the service quotations, an estimate of quality of service is generated. Lastly, the service quotations and the estimate of quality of service are sent to the client.

### COPYRIGHT NOTICE

A portion of the disclosure of this patent document contains material that is subject to copyright protection. The copyright owner has no objection to facsimile reproduction by anyone of the patent document or the patent disclosure as it appears in the Patent and Trademark Office patent file or records but otherwise reserves all copyright rights whatsoever.

### TECHNICAL FIELD

The presently disclosed embodiments are directed to an online marketplace for translation services. More particularly, the presently disclosed embodiments are directed to facilitating transactions between clients and service providers for language translation services.

### BACKGROUND

Various language translation service providers have created translation memories (TMs) which are a corpus of translated words and sentences. However, the usage of these stored TMs is not optimum which has in-turn led to a paucity of translation resources. Facilitators have tried to make available these translation memories for download through various models. However, numerous issues have plagued the wide-spread use of existing translation memories.

One of the models for the use of TMs is through a mutual exchange of resources over the Internet. Service providers can download material from any of the available translation memory in exchange for material from their own TMs. However, service providers are generally wary of such models since there is a possibility that one player might download well-translated documents and in-exchange might upload poorly translated documents. Further, TMs are core assets of LSPs, and sharing them induces strong risks of enabling competitors to serve their own customers.

In light of the forgoing, the usage of TMs on a global scale has been restricted and has in-turn made translation resources prohibitively expensive.

### SUMMARY

According to aspects illustrated herein, there is provided a method for negotiating a transaction in an online marketplace for translation services. The method includes steps of receiving one or more requirements from a client. The one or more requirements are sent to one or more service providers on the basis of which the service providers return a service quotation. On the basis of the statistics and a reputation score of the service providers, a fitness score for the one or more service providers is calculated. Suitable service providers are identified on the basis of the fitness score.

According to aspects illustrated herein, there is provided a method for serving a request in an online marketplace for translation services. The method comprises steps of receiving one or more job inputs from a client, which are then sent to one or more suitable service providers. The method further comprises steps of receiving a job output from the one or more suitable service providers. An estimate of quality of service is generated based on the one or more job inputs and the job output. Further, a payment is received from the client on the basis of a third pre-defined criteria and a pre-determined portion of the payment is subsequently sent to the one or more suitable service providers.

According to aspects illustrated herein, there is provided a system for implementing an online marketplace for translation services. The system comprises a transceiver module configured for receiving requirements from a client and sending the same to one or more service providers. The system further comprises a quality estimation module configured for estimating the quality of service of the one or more service providers; and a payment reception module configured for receiving a payment from the client.

According to aspects illustrated herein, there is provided a computer program product for use with a computer, the computer program product comprising a computer readable program code embodied therein for negotiating a transaction in an online marketplace for translation services. The computer program product comprises program instruction means for receiving one or more requirements from a client. The computer program product further comprises program instruction means for sending the one or more requirements to one or more service providers. The computer program product further comprises program instruction means for receiving service quotations and one or more statistics from the one or more service providers, wherein the one or more statistics are determined on the basis of a first pre-defined criteria. The computer program product further comprises program instruction means for calculating a fitness score of the one or more service providers on the basis of the one or more statistics and a reputation score. The computer program product further comprises program instruction means for identifying the one or more suitable service providers on the basis of the fitness score.

According to aspects illustrated herein, there is provided a computer program product for use with a computer, the computer program product comprising a computer readable program code embodied therein for servicing a request in an online marketplace for translation services. The computer program product comprises program instruction means for receiving one or more job inputs from a client. The computer program product further comprises program instruction means for sending the one or more job inputs to one or more suitable service providers. The computer program product further comprises program instruction means for receiving a job output from the one or more suitable service providers. The computer program product further comprises program instruction means for calculating an estimate of quality of service based on the one or more job inputs and the job output. The computer program product further comprises program instruction means for sending the estimate of quality of service and the job output to the client. The computer program product further comprises program instruction means for receiving a payment from the client on the basis of a third pre-defined criteria. The computer program product lastly comprises program instruction means for sending a pre-determined portion of the payment to the one or more suitable service providers.

### BRIEF DESCRIPTION OF DRAWINGS

The accompanying drawings, which are incorporated in, illustrate various example systems, methods, and other example embodiments of the present disclosure. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

Various embodiments will hereinafter be described in accordance with the appended drawings provided to illustrate and not limit the scope in any manner, wherein like designations denote similar elements, and in which:

FIG. 1 is a block diagram illustrating an online marketplace for language translation services, in accordance with at least one embodiment;

FIG. 2 illustrates a table comprising exemplary job requirements sent by a client 102 and the service statistics received from the service provider 108, in accordance with at least one embodiment;

FIG. 3 is a block diagram illustrating a system for implementing an online marketplace for translation services, in accordance with at least one embodiment;

FIG. 4 is a flowchart illustrating a method for identifying one or more service providers in an online marketplace, in accordance with at least one embodiment; and

FIG. 5 is a flowchart illustrating a method for servicing a request in an online marketplace for translation services, in accordance with at least one embodiment.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed description given herein with respect to the figures is just for explanatory purposes as the method and the system extend beyond the described embodiments. For example, those skilled in the art will appreciate that, in light of the teachings presented, multiple alternate and suitable approaches can be realized, depending on the needs of a particular application, to implement the functionality of any detail described herein, beyond the particular implementation choices in the following embodiments described and shown.

Definition of Terms: Terms not specifically defined herein should be given the meanings that would be given to them by one of skill in the art in light of the disclosure and the context. As used in the present specification and claims, however, unless specified to the contrary, the following terms have the meaning indicated.

“Translation Service” refers to a task to fulfilled by a service provider. In an embodiment, the task can be one of a sentence look-up (in a translation memory), word look-up (in a translation memory), translation of a word or a sentence, and/or translation of a document in a source language to a target language. In accordance with the present disclosure, a service provider uses a proprietary translation memory to provide the translation services.

A “Translation Memory” (TM) refers to a database comprising of sentences or segments of sentences which have previously been translated. In an embodiment, the TM is a resource located at a service provider. The service provider can use the TM to provide translation services to clients.

A “client” refers to an entity which seeks the conversion of a document, sentence, or segments from sentences from a source language to a target language.

A “job” or a “task” refers to the work that a client wishes to get completed.

“Reputation Score” refers to a quantitative value assigned to a service provider on the basis of its historical performance in the online marketplace for translation services. In an embodiment, historical performance reflects the timeliness of the service provider, quality of translation, and so forth. Further, historical performance also comprises feedback received from various clients. It will be appreciated by a person having ordinary skill in the art that the parameters which constitute the historical performance data are not limited to the parameters above. In accordance with the present disclosure, historical performance data and the statistics received from the service providers (on the basis of the client requirements), are used to calculate the reputation score.

“Fitness” refers to the suitability of a service provider for servicing a client request. In accordance with an embodiment, historical performance information can be used to calculate the fitness of a service provider for completing a client request. In accordance with the present disclosure, historical performance data and various statistics received from the service providers (on the basis of client requirements) are used to calculate the fitness of the service provider.

“Translation memory lookup” refers to a search of the translation memory for existing translations which can be used to translate a new document segment.

“Terminology lookup” refers to a search for a term in the translation memory or in a bilingual dictionary.

“Machine Translation” refers to use of software to translate text from one language to another.

“Phrase Table” refers to a table comprising translation of various phrases from one language to another.

“Phrase table lookup” refers to the search of a phrase table for identifying the translation of a phrase from one language to another.

“Language model lookup” refers to the search in a table for identifying usage frequency statistics of a sequence of one or more words in a language.

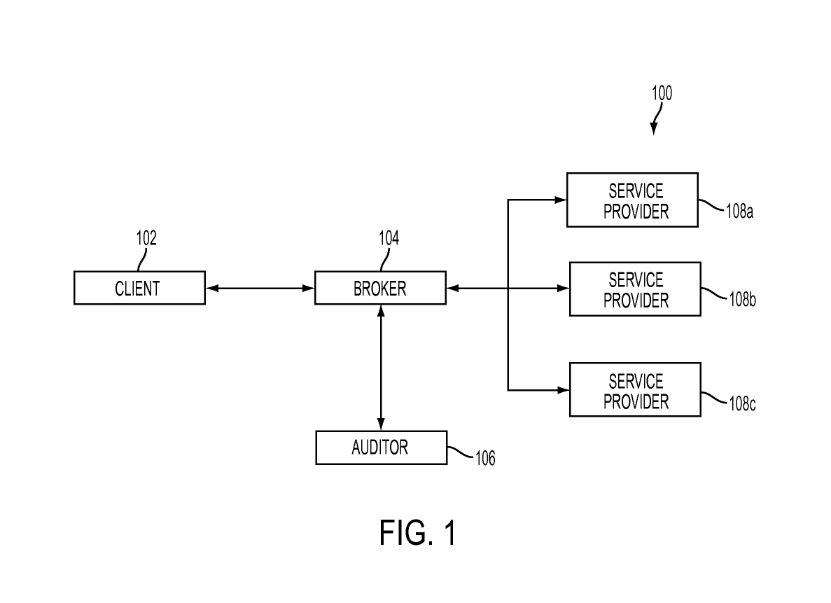

FIG. 1 is a block diagram illustrating an online marketplace for language translation services, in accordance with at least one embodiment. The online marketplace 100 includes a client 102, a broker 104, and an auditor 106. The online marketplace further includes service providers 108a, 108b, and 108c (hereinafter referred to as service providers 108).

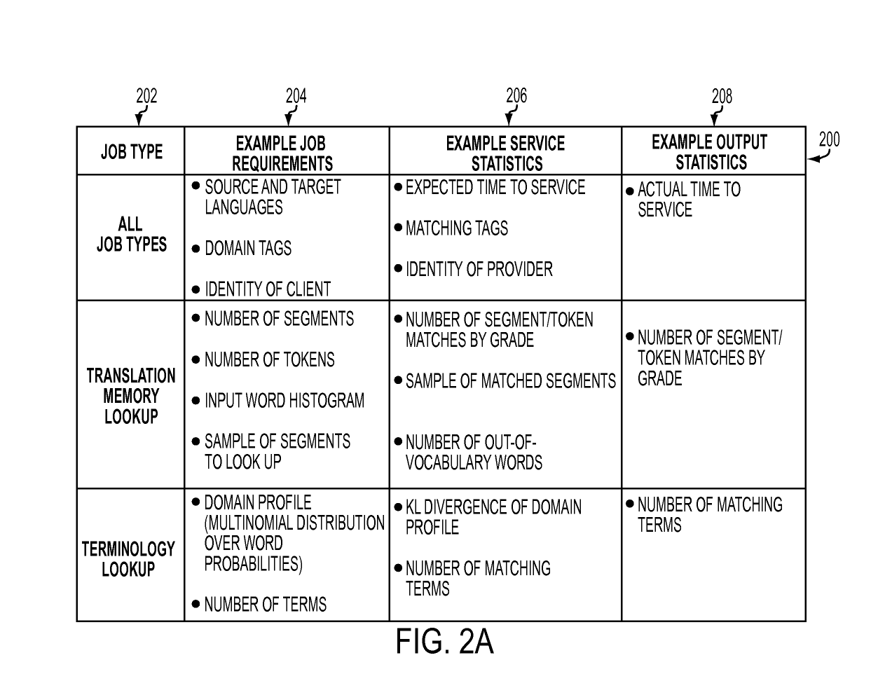

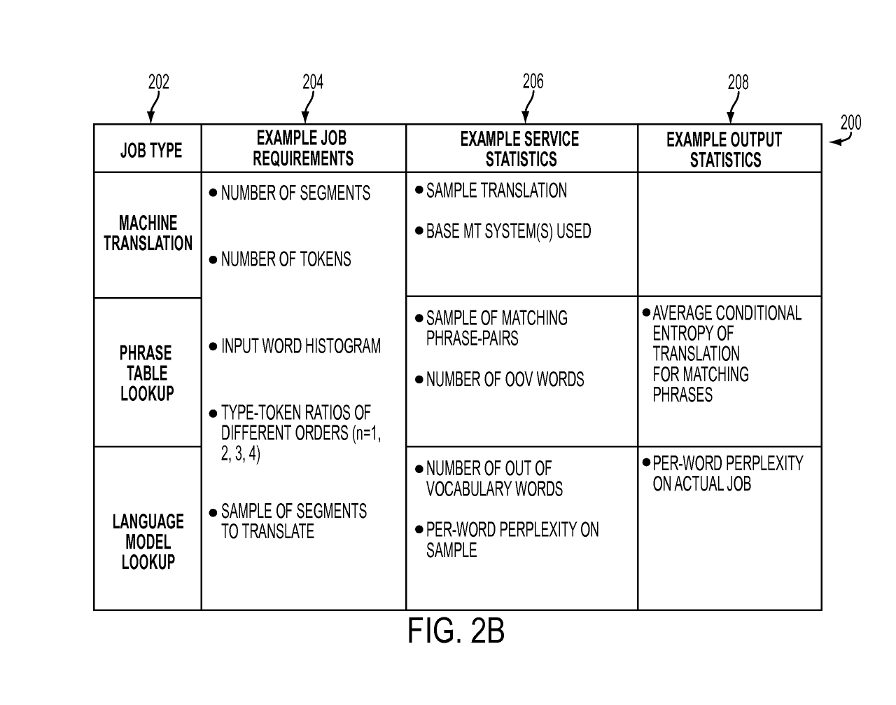

The client 102 submits a request for a language translation service to the broker 104. The broker 104 acts as an intermediary between the client 102 and the service providers 108. The auditor 106 is responsible for verifying the quality of service requests and service outputs. FIG. 1 will now be explained in more detail in conjunction with FIG. 2.

As illustrated in FIG. 1, the client 102 desires to get a quote on a translation task from the service providers 108. To meet this end, the client 102 formulates job requirements describing the task which needs to be completed. In an embodiment, the job requirement can be generated by a software-based system. In another embodiment, the job requirement can be generated by a human operator. In an embodiment, the client 102 may be desirous of obtaining a lookup of one or more segments of a TM, lookup of one or more terms from a terminology, machine translation of one or more segments of a document in a source language, or lookup and retrieval of all phrase pairs matching one or more translation segments. The job requirements are sent by the client 102 to the broker 104

In an embodiment, the broker 104 maintains a list of all the service providers 108 who are members of the online marketplace. The broker 104 sends the job requirements to one or more service providers 108, who then return service statistics to the client 102 on the basis of a first pre-defined criteria. On the basis of the information received from the service providers 108, the broker 104 identifies the service providers who are most suitable to perform the job desired by the client. In an embodiment, the broker 104 identifies the service providers on the basis of a fitness score. The job requirements and the service statistics are explained in more detail in the description for FIG. 2.

FIG. 2 illustrates a table comprising exemplary job requirements sent by a client 102 and the service statistics received from the service provider 108, in accordance with at least one embodiment. As can be seen in FIG. 2A, column 202 lists the various job types which the client 102 can request. For example, column 202 lists the following job types which can be requested by a client: translation memory lookup, terminology lookup, machine translation, phrase table lookup, or language model lookup. It will be appreciated by a person having ordinary skill in the art that the job types listed are only provided as examples and any translation service can be facilitated via the online market place for translation services without departing from the scope of the invention.

The job requirements to be provided by the client 102 are provided in column 204. The job requirements are forwarded by the client 102 to the broker 104 which then send the job requirements to one or more service providers 108. The service providers 108 use a first pre-defined criteria to evaluate whether the job requirements are sufficient to generate the initial quotation and the service statistics. In an embodiment, the first pre-defined criteria is one or more of the requirements listed in column 204. If the service provider 108 judges the job requirements 204 to be sufficient to generate an initial quotation for the work then the service provider 108 compiles service statistics which will be sent to the broker 104. On the basis of information received from the service provider 108 and a historical performance data, the broker 104 calculates a fitness score for the service providers 108. In an embodiment, the broker 104 maintains a reputation score of the service providers 108. The reputation score, in an embodiment, is compiled through historical information available with the broker 104. The historical information includes data points such as feedback received on client engagements from the past, timeliness of a service provider, number of years a service provider has been in the domain of language translation, the size of the service provider's translation memory, and so forth. It will be understood by a person having ordinary skill in the art that that the possible ways of calculating the reputation score for the service provider 108 is only provided as an example and various other known techniques can be used to calculate the reputation score of the service providers 108.

The broker 104 uses this historical information to calculate a reputation score for each of the service providers 108. Further, the broker 104 uses the reputation score and the statistics received from the service providers 108 to determine the ‘fitness’ of a service provider to service the client request. It will be appreciated by a person having ordinary skill in the art that any known technique can be employed to calculate the fitness score of the service providers 108. In an embodiment, the broker 104 uses the fitness score to identify the most suitable service providers. A pre-defined threshold can be used by the broker 104 to identify the service providers 108 on the basis of the fitness score. In an embodiment, the broker 104 forwards the job requirements and the service statistics from the identified service providers 108 to the auditor 106, which on the basis of the information provided by the broker 104, can generate an a-priori estimate of quality of service. The auditor 106 then sends this a-priori estimate of quality of service back to the broker 104 which forwards the same to the client 102. Based on the quotations and the a-priori estimate of quality of service, the client 102 can choose to send the job to the identified service providers 108.

In an embodiment, more than one service provider from the one or more service providers 108 are identified by the broker 104. The quotations and a-priori estimate of quality for all the identified service providers 108 are sent to the client 102. The client 102, on the basis of the information received from the broker 104, can then decide which service providers should the job be sent to.

Once the client 102 has decided, based on the service statistics and the a-priori quality estimate, the service providers 108 who can complete the desired job, the client 102 will send the required job inputs to the broker 104. The broker 104 then forwards it to the service providers 108. The job inputs represent the detailed description of the job which the client 102 wants to get completed by the service provider 108. For the sake of convenience, the identified service provider(s) from the service providers 108 will hereinafter be referred to as service provider 108.

In an embodiment, the job inputs provided by the client 102 can be a document in a source language. The client 102 can ask the service provider 108 to provide translations of certain segments of the document. Once the service provider 108 has completed the translation job, it sends the final output to the broker 104. In an embodiment, the service provider 108 also includes additional job statistics along with the job output. In an embodiment, the additional job statistics are shown in column 208 of FIG. 2A. The broker 104 collects the job output and the additional job statistics and sends the same to the auditor 106 along with the job inputs initially shared by the client 102. The auditor 106 uses the job inputs, the job output and the additional job statistics to generate a-posteriori estimate of quality of service. The auditor 106 then sends the a-posteriori estimate of the quality of service to the broker 104. The broker 104 forwards to the client 102 the collected job outputs with the corresponding a-posteriori estimate of quality of service. It will be understood by a person having ordinary skill in the art that the estimates of quality prior to completing a task and estimates of quality post-completion of task can be used to gauge the quality of service offered by a particular service provider. In an embodiment, the estimates of quality can also be factored in by the broker 104 to calculate reputation scores for the service providers 108. After receiving the final job output, the client 102 can send the payment for the task to the broker 104 in accordance with a second pre-defined criteria. The second pre-defined criteria specifies the pricing model through which the client 102 can make the payment to the broker 104. For example, in an embodiment, the second pre-defined criteria can be one of pay-per-use model or a subscription-based model. In a pay-per-use pricing model, payment can be done either in advance, that is, when the client 102 submits a job input to the broker, or later, once the client 102 has received the job output. The broker 104 can withhold a part of the payment as its own commission and remit the rest to the service providers 108 and the auditor 106. It will be understood by a person having ordinary skill in the art that the commission charged by a broker can be fixed through any known means. For example, in an embodiment, the broker can declare before-hand that a commission of 15 percent will be charged to every service provider. In another embodiment, the broker 104 can declare in the online market place that the client 102 will have to pay the broker 104 a commission of a pre-decided amount. The broker 104 can have a similar agreement with the auditor 106. In another embodiment, the clients 102 can pay a flat subscription fee to the brokers 104, and the broker 104 can pay per-use to the service providers 108.

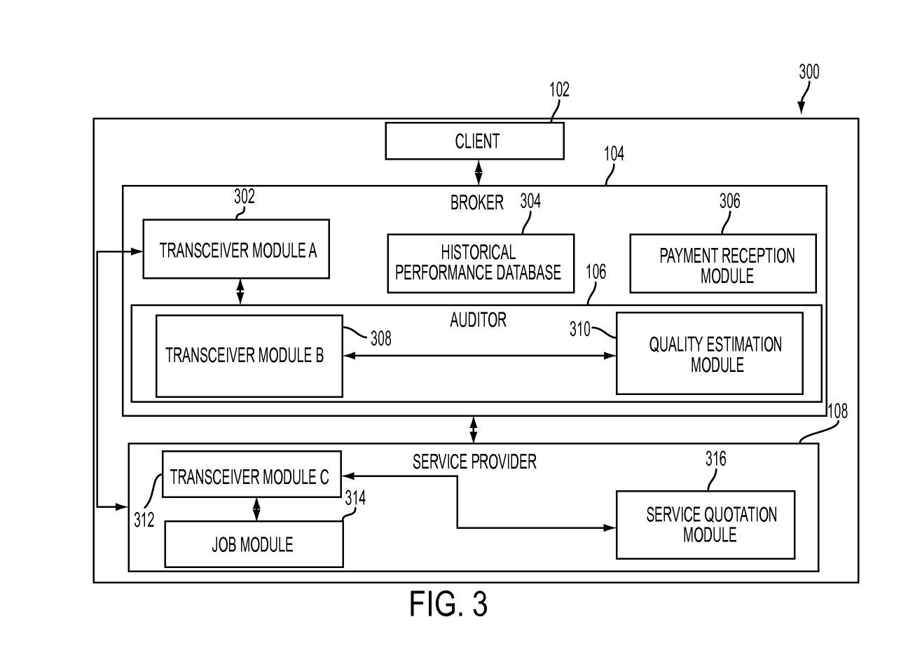

In an embodiment, the broker 104 and the auditor 106 are the same entity. It will be understood by a person ordinarily skilled in the art that all the information used by the auditor 106 to generate the a-priori and a-posteriori estimate of quality are also available at the broker 104. Hence, the broker 104 can perform the function of the auditors 106 through the disclosed embodiments. The various modules of the broker 104, auditor 106, and service provider 108 will now be explained in the detailed description for FIG. 3.

FIG. 3 is a block diagram illustrating a system for implementing an online marketplace for translation services, in accordance with at least one embodiment. FIG. 3 comprises the client 102, the broker 104, the auditor 106, and service provider 108. The broker 104 further comprises a transceiver module A 302, a historical performance database 304, and a payment reception module 306. The auditor 106 further comprises a transceiver module B 308, and a quality estimation module 310. The service provider 108 further comprises a transceiver module C 312, a job module 314, and a service quotation module 316.

As shown in FIG. 3, the client 102 is communicatively coupled to the broker 104. The client 102 formulates job requirements to be sent to the broker 104. The job requirements, at the client 102, can either be formulated by software or by a human operator. The job requirements are initial statistics which are meant to provide to the service providers 108 an estimate of the complexity of the task. The job requirements are received by the transceiver module A 302 located at the broker 104, which then forwards the same to the service providers 108. The job requirements are received by the transceiver module C 312 located at the service provider 108. The transceiver module C 312 is communicatively coupled to a service quotation module 316. The service quotation module 316, on the basis of the received job requirements, generates service statistics and a service quotation for the translation job and sends it back to the transceiver module C 312. The transceiver module C 312 sends the service statistics to the broker 104. The job inputs, service quotation, and the service statistics are sent by the transceiver module A 302 to the transceiver module B 308. The transceiver module B 308 is communicatively coupled to the quality estimation module 310. The quality estimation module 310, on the basis of the job inputs, service quotation and the service statistics prepares an a-priori estimate of the quality of service of the one or more service providers and sends it to the transceiver module B 308. The transceiver module B 308 sends the a-priori estimate of the quality of service to the transceiver module A 302. Further, broker 104 accesses information on the performance of the service providers from the historical performance database 304. In an embodiment, the historical performance database 304 is configured to calculate a reputation score for the service providers 108 on the basis of the historical performance data. The broker 104 uses the reputation score and the service statistics received from the service providers 108 to calculate ‘fitness’ of one or more service providers from the service providers 108. In an embodiment, the historical performance database contains past information on the performance of various service providers. The broker 104 uses the information to calculate a fitness score for the service providers 108. Only the service providers for which the fitness score is above a pre-defined threshold are identified for the job.

The transceiver module A 302 then collates the service quotations, a-priori estimate of the quality of service and the service statistics for the identified service providers and sends it to the client 102. Based on the information received, the client 102 decides which service provider should the job be sent to. The job inputs detailing the task are then sent by the client 102 to the broker 104 and are received by the transceiver module A 302. The job inputs are sent by the transceiver module A 302 to the service provider 108 and are received by the transceiver module C 312. The transceiver module C 312 is communicatively coupled to a job module 314, which is responsible for fulfilling the task on the basis of the received job inputs. In an embodiment, the job module 314 accesses a TM (not shown) to fulfill the task. In an embodiment, the job module 314 also generates additional statistics related to the job output. The additional statistics on the job output are listed in column 208 of FIG. 2.

The job module 314 then sends the job output and the additional statistics to the transceiver module C 312, which forwards the same to the transceiver module A 302. The transceiver module A 302 compiles the job output and the additional statistics and forwards the same to the transceiver module B 308 at the auditor 106. The quality estimation module 310 uses the job output and the additional statistics to calculate an a-posteriori estimate of the quality of service.

The a-posteriori estimate of the quality of service is then sent by the quality estimation module 310, which then forwards it to the transceiver module B 308. The transceiver module B 308 subsequently sends the a-posteriori estimate of the quality of service to the transceiver module A 302. The transceiver module A 302 compiles the job output, additional statistics and the a-posteriori estimate of the quality of service and sends it to the client 102. The client then remits the payment for the job to the broker 102 and the same is received at the payment reception module 304. The various payment models have been discussed in more detail in the detailed description for FIGS. 1 and 2.

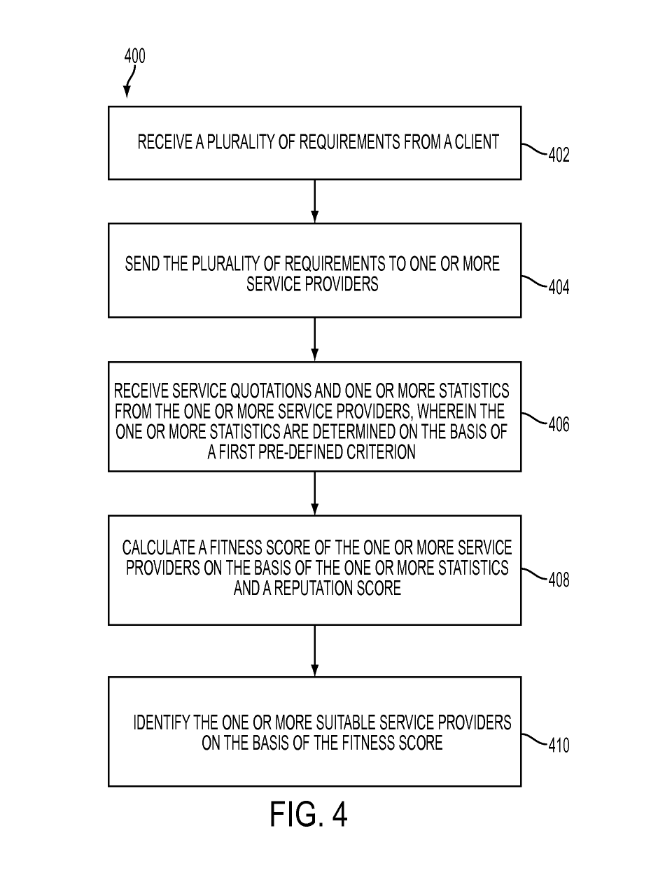

FIG. 4 is a flowchart illustrating a method for identifying one or more service providers in an online marketplace, in accordance with at least one embodiment.

At step 402, a plurality of requirements are received by the broker 104 from the client 102. In an embodiment, the plurality of requirements are the job requirements which are meant to give the service providers 108 an idea of the nature and complexity of the task. The broker 104 receives the job requirements and forwards the same to service providers 108 at 404. Based on the job requirements, the service providers 108 formulate a service quotation at 406 and send it to the broker 104. The broker 104 forwards the service quotation and sends the same along with the job requirements to an auditor 106. The auditor 106, based on the service quotation and the job requirements generates a-priori estimate of the quality of service at 408. The a-priori estimate of the quality of service is sent by the auditor 106 to the broker 104. The broker 104 then sends the service quotation and the a-priori estimate of the quality of service to the client 102 at 410. Detailed explanation of the process involved in negotiating a transaction in an online marketplace has been provided in the description for FIGS. 1 and 2, in accordance with an embodiment.

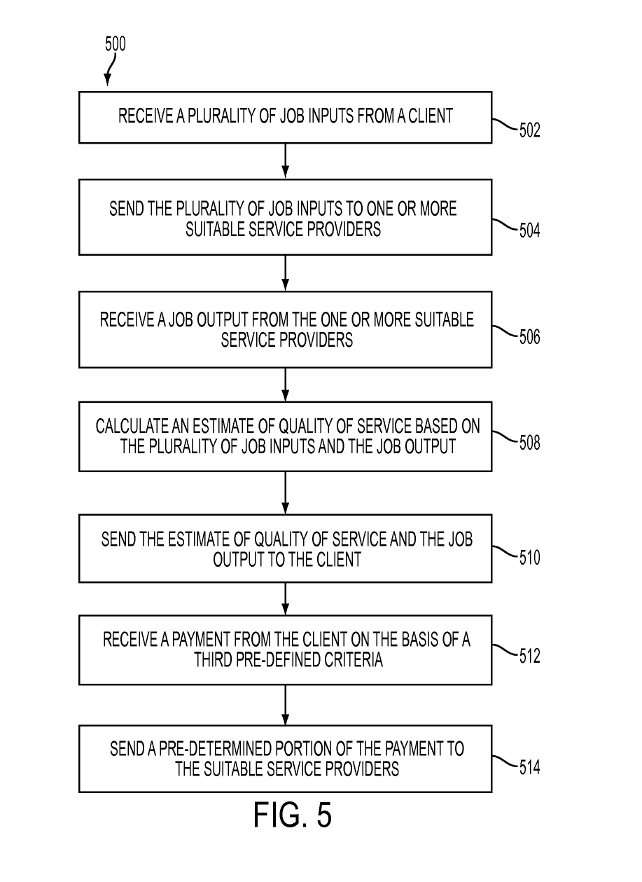

FIG. 5 is a flowchart illustrating a method for servicing a request in an online marketplace for translation services, in accordance with an embodiment.

At 502, a plurality of job inputs are received from the client 102 by the broker 104. Post-receiving the service quotation and the a-priori estimate of quality of service, the client can decide whether the job should be sent to service provider 108. In an embodiment, the job inputs are the detailed description of the translation task required to be completed by the service provider 108. The broker 102 sends the job inputs to the service provider 108 at 504. The service providers 108 completes the translation task and sends the job output to the broker 104 at 506. The service provider 108 also generates additional statistics about the job output and sends the same to the broker 104. A discussion on the additional statistics has been provided in the detailed description for FIGS. 1 and 2, in accordance with an embodiment.

The broker 102 forwards the job inputs, job output and the additional statistics to the auditor 106, which then calculates an a-posteriori estimate of the quality of service at 508. The a-posteriori estimate of the quality of service is sent by the auditor 106 to the broker 102. The broker 102 forwards the job output and the a-posteriori estimate of the quality of service to the client 102 at 510. In an embodiment, the broker 104 also sends the additional statistics to the client 102. At 512, the client 102 sends the payment for the translation task to the broker 104 in accordance with a third pre-defined criteria. The various models which can be used for making the payment to the broker 104 have been discussed in more detail in the detailed description for FIGS. 1 and 2. At 514, the broker 104 sends payment to the service provider 108 after deducting its own commission for mediating the transaction.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, ‘Windows’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer code disclosed above have numerous advantages. It will be appreciated by a person ordinarily skilled in the art that the disclosed embodiments facilitate provisioning of an online market place for translations service. In an embodiment, the disclosure will facilitate increased interaction by clients and service providers. In another embodiment, quantitative measures provide an accurate measure of the reputation of a service provider in the market place. It will be appreciated by a person having ordinary skill in the art that the disclosed embodiments will also provider a very high level of granularity in the kind of service requests which can be fulfilled. The provisioning of an online market place will enable clients to order very small scale to very large scale translation services. For example, a client can request a translation service as small as a word look-up and as large as a full document translation. In an embodiment, the large scale availability of Translation Memories is also expected to increase manifold the development of machine translation services. In an embodiment, an online marketplace enabling the sharing of language resources but limiting the physical transfer of data is likely to suffer less from copyright and IP concerns. As disclosed above, the client initially provides only statistics on the job to be completed. The service provider in return also returns statistics. Hence, physical transfer of copyright data is reduced.

It will be appreciated by a person having ordinary skill in the art that the system, modules, and sub-modules have been illustrated and explained to serve as examples and should not be considered limiting in any manner. It will be appreciated that the variants of the above disclosed system elements, or modules and other features and functions, or alternatives thereof, may be combined to create many other different systems or applications.

Those skilled in the art will appreciate that any of the foregoing steps and/or system modules may be suitably replaced, reordered, or removed, and additional steps and/or system modules may be inserted, depending on the needs of a particular application, and that the systems of the foregoing embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

What is claimed is:

1. A method for identifying one or more suitable service providers in an online marketplace for translation services, the method comprising:
receiving one or more requirements from a client;
sending the one or more requirements to one or more service providers;
receiving service quotations and one or more statistics from the one or more service providers, wherein the one or more statistics are determined on the basis of a first pre-defined criteria;
calculating a fitness score of the one or more service providers on the basis of the one or more statistics and a reputation score; and
identifying the one or more suitable service providers on the basis of the fitness score.

2. The method of claim 1, wherein the translation service comprises one or more of a translation memory lookup, a terminology lookup, a machine translation, phrase table lookup, or a language model lookup.

3. The method of claim 1, wherein the requirements comprise a plurality of statistics about a translation job.

4. The method of claim 1, wherein the fitness score indicates suitability of the one or more service provider to meet the client requirements.

5. The method of claim 1, wherein the reputation score is calculated on the basis of historical data.

6. The method of claim 1 further comprising calculating an estimate of quality of service of the one or more service providers based on the one or more requirements and the service quotations.

7. A method for serving a request in an online marketplace for translation services, the method comprising;
receiving one or more job inputs from a client;
sending the one or more job inputs to a one or more suitable service providers;
receiving a job output from the one or more suitable service providers;
calculating an estimate of quality of service based on the one or more job inputs and the job output;
sending the estimate of quality of service and the job output to the client;
receiving a payment from the client on the basis of a second pre-defined criteria; and
sending a pre-determined portion of the payment to the one or more suitable service providers.

8. The method of claim 7, wherein the one or more suitable service providers generate additional statistics pertaining to the job output.

9. A system for implementing an online marketplace for translation services, the system comprising:
a transceiver module configured to receive one or more requirements from a client; and
send the one or more requirements to one or more service providers;
a quality estimation module configured for estimating the quality of service of the one or more service providers; and
a payment reception module configured for receiving a payment from the client.

10. The system of claim 9, wherein the transceiver module is further configured to receive a plurality of inputs required to perform a job from a client.

11. The system of claim 9, wherein the transceiver module is further configured to receive a job output from the one or more of service providers.

12. The system of claim 9, wherein the transceiver module is further configured to send a quality estimate and a job output to the client.

13. The system of claim 9 further comprising a historical performance database for storing historical performance data of one or more service providers.

14. A computer program product for use with a computer, the computer program product comprising a computer readable program code embodied therein for identifying one or more suitable service providers in an online marketplace for translation services, the computer readable program code comprising:
program instruction means for receiving one or more requirements from a client;
program instruction means for sending the one or more requirements to one or more service providers;
program instruction means for receiving service quotations and one or more statistics from the one or more service providers, wherein the one or more statistics are determined on the basis of a first pre-defined criteria;
program instruction means for calculating a fitness score of the one or more service providers on the basis of the one or more statistics and a reputation score; and
program instruction means for identifying the one or more suitable service providers on the basis of the fitness score.

15. A computer program product for use with a computer, the computer program product comprising a computer readable program code embodied therein for servicing a request in an online marketplace for translation services, the computer readable program code comprising:
program instruction means for receiving one or more job inputs from a client;
program instruction means for sending the one or more job inputs to one or more suitable service providers;
program instruction means for receiving a job output from the one or more suitable service providers;
program instruction means for calculating an estimate of quality of service based on the one or more job inputs and the job output;
program instruction means for sending the estimate of quality of service and the job output to the client;
program instruction means for receiving a payment from the client on the basis of a third pre-defined criteria; and
program instruction means for sending a pre-determined portion of the payment to the one or more suitable service providers.
